(19) United States
(12) Patent Application Publication
(10) Pub. No.: US 2025/0252349 A1
(43) Pub. Date: Aug. 7, 2025

(54) CONTEXT OPTIMIZATION FOR CONTEXT-BASED TABULAR CLASSIFICATION

(71) Applicant: THE TORONTO-DOMINION BANK, TORONTO (CA)

(72) Inventors: Anthony Lawrence Caterini, TORONTO (CA); Junwei Ma, TORONTO (CA); Guangwei Yu, TORONTO (CA); Valentin P. Thomas, TORONTO (CA)

(21) Appl. No.: 18/672,874

(22) Filed: May 23, 2024

Related U.S. Application Data
(60) Provisional application No. 63/550,478, filed on Feb. 6, 2024.

(51) Int. Cl. G06N 20/00

(52) U.S. Cl. CPC G06N 20/00

(57) ABSTRACT

A tabular modeling system uses a tabular data model to predict data sample classification for input data samples. When applied, the tabular data model receives a context and an input data point and outputs a classification of the input data. When the tabular data model is applied to a new training set, the tabular modeling system optimizes the context for the new training set by fixing model parameters while modifying context points with respect to the training data set. This enables the tabular data model to learn effective contexts for different data sets.

### CROSS-REFERENCE TO RELATED APPLICATION

This application claims the priority benefit of U.S. Provisional Application No. 63/550,478, filed Feb. 6, 2024, the contents of which are hereby incorporated by reference in the entirety.

### BACKGROUND

This disclosure relates generally to computer model classification with context inputs, and particularly to optimizing the context used for a subject data set.

Computer models for tabular data classification have typically used tree-based models, such as XGBoost, that train model parameters directly on the data to be classified. In more recent developments, a transformer-style model may learn a set of model parameters used in conjunction with a “context” to evaluate a current data sample. This type of model may use the context to describe the current data set or as a “memory” for recent data items. When parameters of the model is trained with a variety of data set types, the context may be used to describe data points in a given data point currently being evaluated. While this approach may provide for some pre-training and transfer learning in the context of tabular data, there can be significant problems using this type of model effectively with new data.

First, such contexts are typically relatively small compared to the data set from which the new data point is drawn (e.g., the context may describe 100 data points in a data set of 10,000 or more data points) and selecting optimal points from the data set to serve as the context may be a difficult task. In many cases, these models also use mechanisms, such as attention, that quadratically scale with respect to the number of data points in the context and thus significantly penalize increased context size as an approach for resolving the limited information provided by the context. The limited size of the context can limit efficacy of this type of model as the context cannot effectively describe the contours of the data set.

### SUMMARY

To improve performance of these models, the context for a particular data set is optimized to enable a model for tabular data to perform well on larger data sets that may be significantly larger than the context for the model. This enables effective use of the fixed size of the context and tailoring of the context to the data set and can enable effective use of tabular data models trained on other data sets without fine-tuning the model parameters to the current data set.

The computer model may have its parameters pre-trained on a variety of different tabular data sets. Each data sample, or “instance,” may be represented by a plurality of features that may be disjoint from one another. When forming a prediction, the computer model receives a context including a plurality of data points along with a data point for which to make a classification.

To more effectively use the model for a new training set (e.g., for a particular task that may have a training set different from the set(s) used to train the model), the context for the model is optimized for the training set. Rather than fine-tune the model with respect to the training set, the model parameters may be held constant, such that the context points are optimized to optimize performance of the model on the training data set. That is, the training sample classification, based on the context and the training point, is used to determine a loss with respect to the training data labels and then optimize the context used for that data set. To do so, the loss may be backpropagated through the model to modify the context points (while keeping the model parameters constant). In this way, the context points are learned that improve the classification of the model with respect to the training data set. As such, the learned context may identify a number of context points, which may be different from actual data points in the training data, that can effectively be used by the model parameters to “learn” classification boundaries in the training data set without modifying the size of the context (e.g., the number of context points) used by the model or the learned model parameters.

As such, to use the model with new data points, the context related to the new data can be input to the model along with the new data point for effective classification. This may mean the same model (and parameters) may be reused with different data sets easily by setting the appropriate context trained on the different data sets without reloading an entirely different model. Although they may come from different data sets, because the individual contexts are learned to optimized for each data set, the contexts can effectively represent each data set for input to the trained model.

### BRIEF DESCRIPTION OF THE DRAWINGS

FIG. 1 shows a tabular modeling system that includes a tabular data model, according to one embodiment.

FIG. 2 shows an example of a tabular data model, according to one embodiment.

FIG. 3 shows a data flow for training a context for a context training data set, according to one embodiment.

FIGS. 4A-4D show examples of context points for a context during training iterations, according to one embodiment.

FIG. 5 provides an example chart of the accuracy of various models as affected by the number of context training examples.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

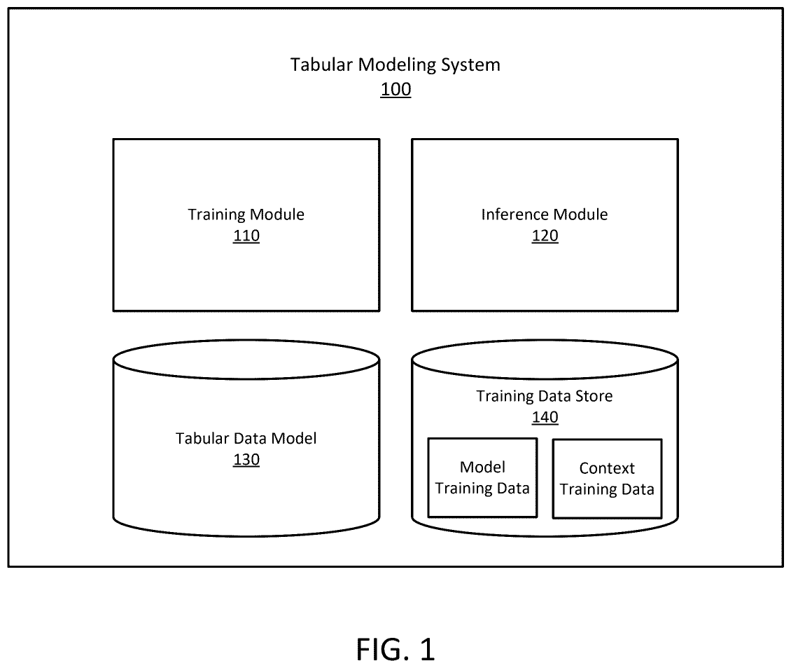

FIG. 1 shows a tabular modeling system 100 that includes a tabular data model 130, according to one embodiment. The tabular modeling system 100 includes various modules and data stores for training and using the tabular data model 130. In practice, additional or different modules and data stores may also be included in the tabular modeling system 100. In addition, the tabular modeling system 100 is shown here without connections to other systems; in practice, the tabular modeling system 100 may be connected to other systems and devices through a suitable network, such as the Internet, for receiving training data and applying the tabular data model 130 to new data items in inference.

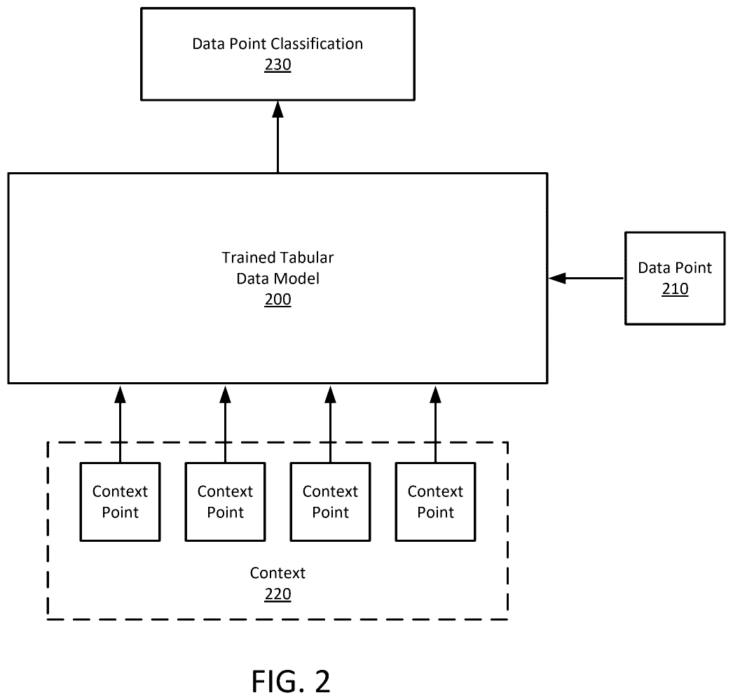

The tabular data model 130 is a trained computer model that learns parameters for interpreting tabular data and predicting data sample classification for an input data sample. The tabular data model 130 receives an input data sample along with a “context” that includes a plurality of context data points as further discussed below and particularly in FIG. 2. For a tabular data sample (which may also be referred to as a “data point”), the information of a particular data sample may include a plurality of features that may be independent from one another, and may represent, for example, patient data for a hospital or financial data for an individual. That is, the independence of different tabular data features/characteristics may differentiate this type of data from other types of data, such as image, sound, or video, where the data may be expected to contain higher degrees of correlation across portions of the input. For example, individual adjacent pixel data in an image is often similar in value, and the difference may be analyzed to determine something meaningful about the image (e.g., edge detection based on nearby pixel differences). The classification may describe, for example, membership in a particular group or a decision to be applied to a data point.

FIG. 2 shows an example of a trained tabular data model 200, according to one embodiment. A trained tabular data model 200 receives a data point 210 (e.g., features describing a data point) along with a context 220 and processes the data point 210 and the context 220 according to parameters of the trained tabular data model 200 to generate a data point classification 230. The trained tabular data model 200 may include a number of computer model processing layers (such as fully-connected layers, perceptrons, attention layers, activation layers, and so forth) with configurable parameters for processing the data point 210 and context 220 to yield the data point classification 230. As discussed below, the trained tabular data model 200 includes parameters trained with a variety of data set types as model training data. As such, the trained parameters of the model have been trained on various data sets with a variety of data set distributions and types of tabular data.

To apply the trained tabular data model 200 with a particular data set, the context 220 provides information about other points (i.e., the context points) within the particular data distribution in which the data point 210 appears. The trained tabular data model 200 may apply one or more attention layers to the context points and/or data point, and in some embodiments may be a transformer-style computer model. In some embodiments, the trained tabular data model is a TabPFN (Tabular Prior-Data Fitted Network) architecture. In some embodiments, the parameters of the trained tabular data model 200 are pre-trained from the perspective of the tabular modeling system 100. As such, the trained tabular data model 200 may encode various types of prior distributions and related processing in the parameters of the trained tabular data model 200, such that the context 220 may be used to describe the particular distribution for evaluating the current data point 210.

In general, however, the number of context points are relatively few and may be 100, 500, or 1000 context points, and may be smaller than the total number of data points available for the data set related to the context. As the transformer architecture and attention mechanisms may scale model complexity and/or runtime quadratically and the trained tabular data model 200 may be pre-trained by another system, modifying the length of the context (e.g., to account for additional context points) may significantly increase processing time or other costs of the trained tabular data model 200. As discussed further below, the context for a particular data set may be trained to enable refined evaluation of the data point classification for that data set without requiring retraining (e.g., fine-tuning) of the trained tabular data model 200.

Returning to FIG. 1, in operation, the tabular data model 130 processes a data point and a context to generate a data point classification. Before inference with an interference module 120, the tabular modeling system 100 includes a training module 110 that may train parameters and other configuration settings of the tabular data model 130 and also train an optimal context for applying the model with a particular data set. The training data 140 may include training data related to various data samples, which may be referred to as “data points” or “instances,” to be used for determining parameters of the model. The training data store 140 may thus include two types of training data: model training data used to train model parameters, and context training data used to optimize the context for a particular data set. As such, the model training data may be used to train parameters of the model, while the context training data may be used to fine-tune the model for a particular data set by fine-tuning the application of the model with a context that is calibrated for that data set (i.e., a particular set of context training data). The tabular data model 130 may thus be trained on various data sets suitable for transfer learning (with an appropriate context) to a variety of other data sets using the context.

As discussed further below, the training process may thus include one training phase that for learning parameters for the tabular data model 130 with the model training data, that learns general relevant relationships among data instances for the various training data sets. To apply the trained model to a new data set, another training phase may “learn” a context that optimizes the context for application to a particular data set (e.g., the context training data).

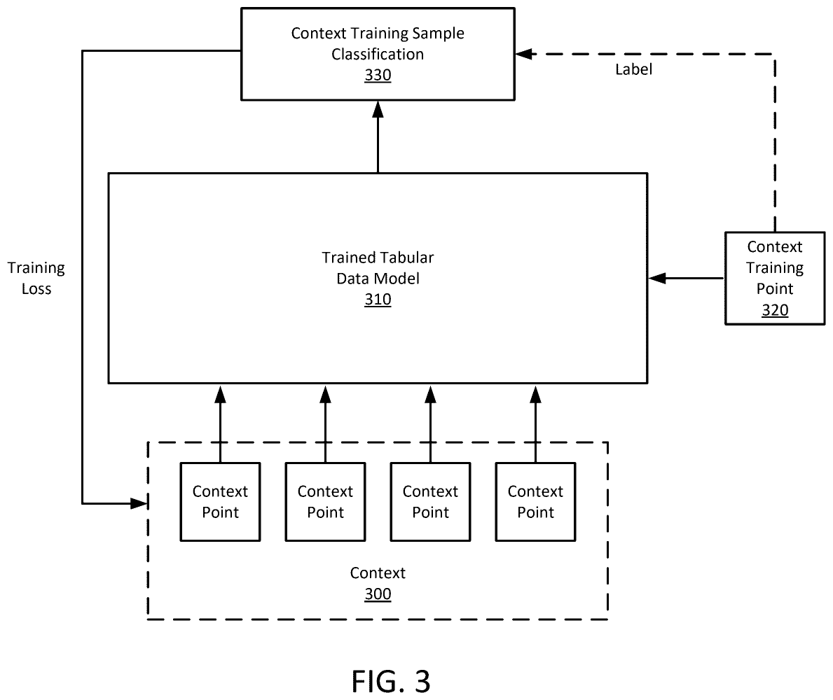

The model training data may be used to train parameters of the tabular data model 130. In some embodiments, the tabular data model 130 is trained by another system and is received by the tabular modeling system 100 as pre-trained. The model training data may include a number of different types of tabular data with different types of relationships between data points, features, and classifications. As such, the model training data may include various distributions with different types of data set contexts. The tabular data model 130 may be trained for various types of data distributions based on the variety of data distributions in the model training data.

Where the model training data may be used for training parameters of the tabular data model 130, the context training data may be used to learn a context for a particular data set. The context training data may thus be one way to “fine-tune” the model's application for that data set by modifying the context. By learning a context, in some embodiments, the parameters of the tabular data model 130 are not modified to adjust the model classifications to a particular data set. For a particular data set, an optimal context may be learned for that data set and then used during inference, without requiring fine-tuning of the tabular data model 130 (i.e., the model parameters). Additional details of the context optimization process is discussed with respect to FIG. 3 and below. For each data set on which the tabular modeling system 100 may perform a prediction (i.e., inference), the training module 110 optimizes a context using context training data of that data set. That is, the context training data may include a plurality of different data sets, and a separate context may be trained for each of the data sets.

To perform inference on a new data item, an inference module 120 receives a new data point and identifies the data set associated with the new data point. The associated data set is used to identify the related context optimized for that data set. The context, optimized for that data set, may then be provided as an input to the model along with the data point to determine a classification output for that item, as shown in FIG. 2. The inference module 120 may thus receive data samples from various sources (such as external devices), identify the learned context relevant to the respective data samples, and classify the data samples with the tabular data model 130 based on the respective contexts. As this process enables learning effective contexts for different data sets, the same tabular data model 130 can be applied to different data sets (e.g., different data distributions) by modifying the context at input, enabling re-use of the same tabular data model 130 and avoiding otherwise expensive memory operations of loading separate tabular data models 130 for different data sets. As the number of parameters in the tabular data model 130 may be very large (e.g., in the hundreds of thousands, millions, or billions), this may significantly improve performance of the tabular modeling system 100, particularly when different data sets are used in practice.

The tabular modeling system 100 is shown in relation to the components particularly related to the improved operation and training of the tabular data model 130 as discussed herein. As such, the particular environment in which the tabular modeling system 100 operates may differ in various embodiments, as the tabular modeling system 100 may be operated on a server that receives requests from remote computing systems for application of requests to the tabular data model 130. In other embodiments, the tabular data model 130 may be trained by one computing system and deployed to another computing system for application (e.g., download by a mobile device for operation of the tabular data model 130). In additional embodiments, the training of the tabular data model 130 may also be separated to different computing systems training of the model parameters with the model training data may be performed by one system, and training of a context for a data set using the context training data may be performed by another system. As such, the tabular modeling system 100 is any suitable computing system; components as disclosed below may be separated or combined appropriately across different computing systems for operation. For example, training of the tabular data model 130 may also be executed by a plurality of systems in parallel that may share information about modifying model parameters during training. Similarly, further components and features of systems that may include the tabular modeling system 100 itself and systems that may include components of the tabular modeling system 100 may vary and include more or fewer components than those explicitly discussed herein.

FIG. 3 shows a data flow for training a context 300 for a context training data set, according to one embodiment. The context 300 may be learned to represent a data set of context training data, such as example data in a particular domain or a particular data distribution. While the associated data set may have 10,000, 100,000, 1M, or more data points, the context 300 may include significantly fewer data points, such that the context is trained to effectively represent the data set for processing by a trained tabular data model 310. During the context training process, the parameters of the trained tabular data model 310 may be fixed. As such, the trained tabular data model 310 may be pre-trained from the perspective of the data set used to train the context 300.

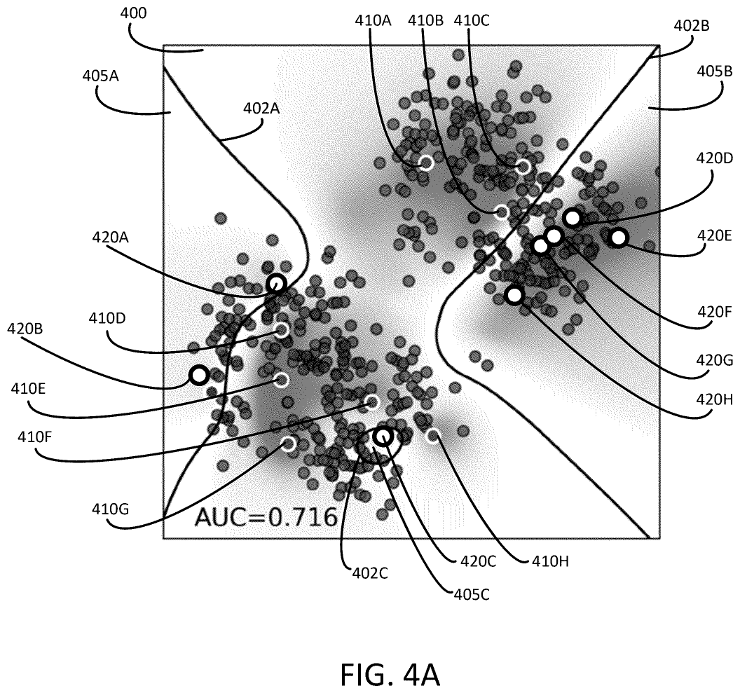

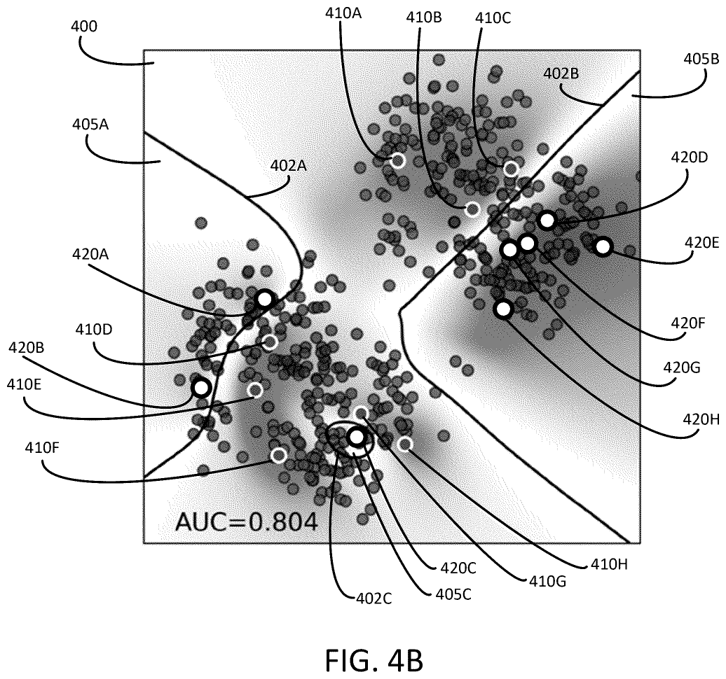

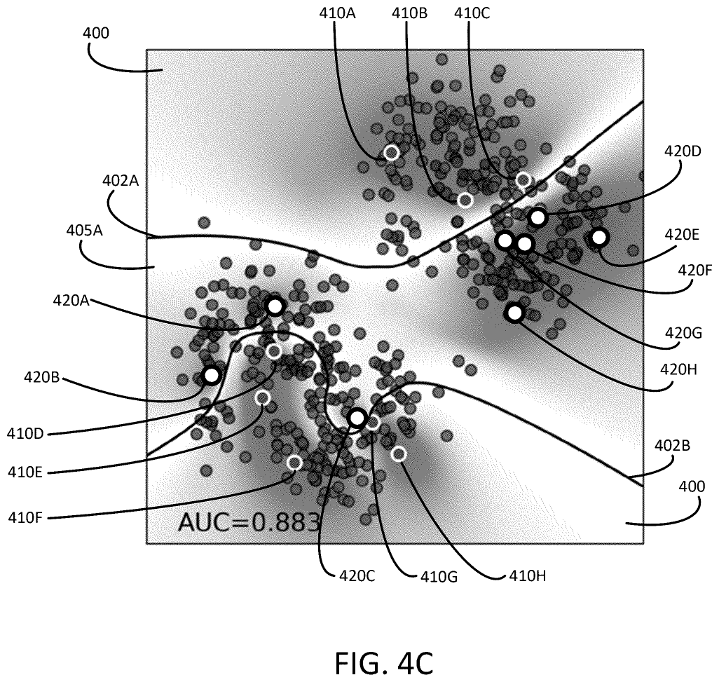

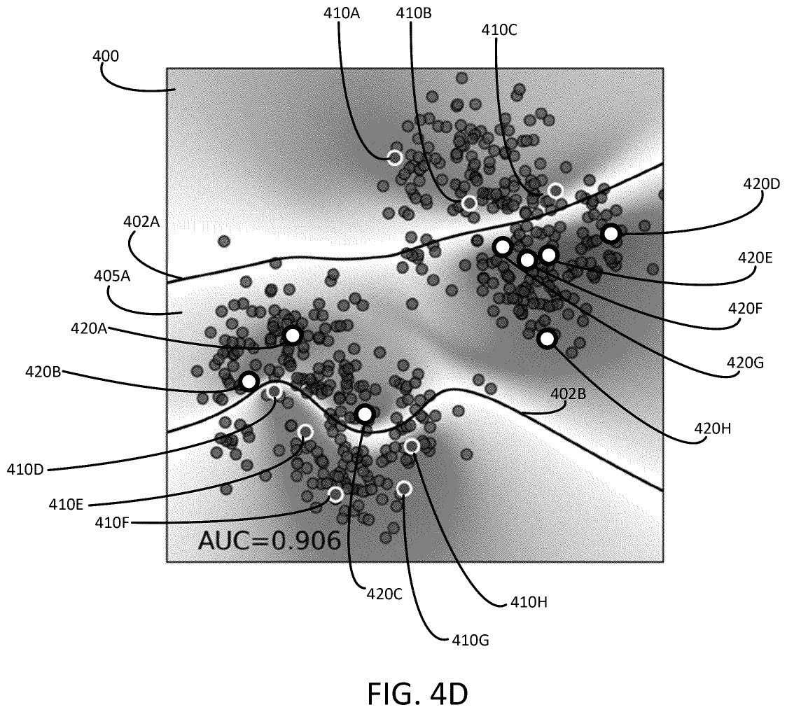

Initially, the context 300 may be initialized with a set of context points randomly selected from the context training set (i.e., real data points from the context training set). Alternatively, the context points may be initialized to random values and modified during the training of the context 300. Rather than using context points of the context training set, during training of the context 300, the context points learned for the context points may be learned during the training. That is, the learned context points are learned to be the context points that best represent the context training data for the purpose of classification with the trained tabular data model 310. The context 300 thus includes context points that may effectively be synthetic and created as a result of the training process. In effect, the context 300 learns values for the context points that improve performance of the trained tabular data model 310 based on the context training data set. FIG. 4 shows an example of the learned context points changing over time as the context is trained.

To modify the context, individual context training points (e.g., as one point in a batch or iteration of training), such as context training point 320, are input to the trained tabular data model 310 along with the current context 300 to generate a context training sample classification 330. This represents the predicted classification given the model parameters as applied with the current context 300 and for the context training point. The context training sample classification 330 may then be compared with the label for the context training point 320 to generate a loss of the context training sample classification. The training loss may then be applied to modify parameters of the context 300. That is, the training loss may modify the values of the context points to improve the classification output generated by the trained tabular data model 310 for the context training point 320.

Formally, the training loss is a function of the model parameters, the value of the context points in the context 300, and the input context training points 320 of the context data set. One or more (typically a batch or the set of all context data points) of the context training points are applied to the trained tabular data model 310 with the current context 300, and the training loss is determined by comparing the respective labels with the context training sample classification 330 to determine the training error.

Using the training error, the context (e.g., the values of the context points) may then be modified by backpropagating the training loss through the trained tabular data model 310 and applying the backpropagated error to the context 300. In other embodiments, the context may be optimized based on the training loss by any other suitable method that modifies the context to reduce the training error. The context may be iteratively trained with any suitable technique, such as gradient descent, with a number of iterations to determine an optimal value (e.g., a convergence or a local minima/maxima) for the context points.

After training, the context 300 may include context points that represent the context training set with only a few examples (i.e., the number of context points) that, in many cases, can provide performance similar to a data model with parameters trained on the context data set. In these examples, improved performance can be achieved by training the context for the data set, rather than the model parameters of the trained tabular data model 310. In this sense, the context points may also represent a form of data distillation for the context training points in the context training set by representing the context training points with the reduced number of learned context points. In this instance, however, because the trained tabular data model 310 has a limited number of data points that can be input as the context 300, the “distilled” context points improve performance of the trained context 300 relative to directly using the context training points in the context training set. This is in contrast to common distillation approaches in which data distillation is expected to generally reduce performance relative to using the original data set.

FIGS. 4A-4D show examples of context points for a context during training iterations, according to one embodiment. In the examples of FIGS. 4A-4D, a set of context training points from a synthetic data set of a two “half-moon” distribution are shown. In this example, the context includes 8 positive and 8 negative context points and are visualized in a 2-dimensional space. The graphs of FIG. 4A-4D illustrate decision boundaries 402 that separate a first region 400 for a positive classification (output classification greater than 0.5) from a second region 405 for a negative classification (output classification less than 0.5). A set of positive context points 410A-H are context points classified as positive along with a set of negative context points 420A-H. The decision boundaries 402 and first region 400 and second region 405 are determined by evaluating input values at different positions given the model parameters, and a context defined by the positive context points 410A-H and negative context points 420A-H. As such, the visualizations in examples 4A-4D illustrate the evaluation of different input points based on the context.

FIGS. 4A-4D illustrate the changing position of the positive context points 410A-H and negative context points 420A-D over several training iterations. In the initial example of FIG. 4A, the model's accuracy is 0.716, which improves over training iterations to 0.906 in FIG. 4D. In this example, FIG. 4A shows the results at initialization (e.g., selecting random points in the context data set as the positive and negative context points), FIG. 4B shows 100 training iterations, FIG. 4C shows 200 training iterations, and FIG. 4D shows 400 training iterations.

As a result of the changed context points, the first region 400 and second region 405, along with the boundaries between them (output classification value of 0.5) also changes. At the initial configuration of FIG. 4A, boundaries 402A, 402B primarily separate the input region into a first region 400 for positive classifications with larger regions 405A and 405B for negative classifications. However, a negative training point 420C causes a decision boundary 402C and region 405C within the positive region 400. As shown in the transitions between FIGS. 4A to 4D, with additional training iterations, positive context points 410A and negative context points 420A-H change position resulting in improved boundaries that provide two positive regions 400A-B and one negative region 405. As a result of learning different positive context points 410A-H and negative context points 420A-H, the model accuracy improved significantly while maintaining the same model parameters (i.e., by changing the context but not fine-tuning the model).

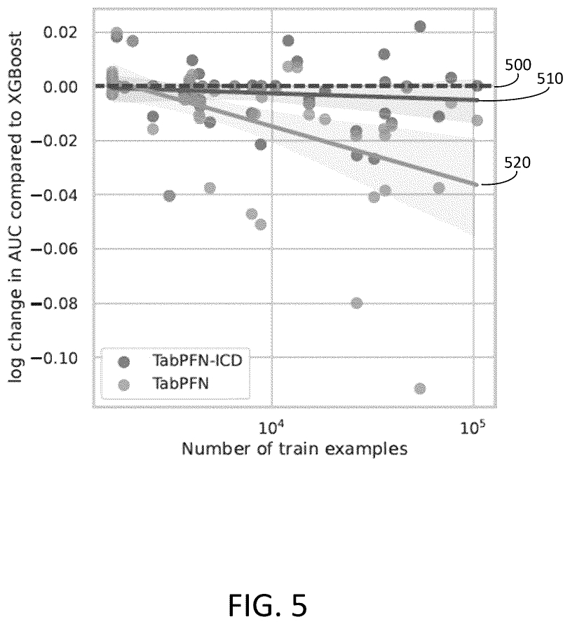

FIG. 5 provides an example chart of the accuracy of various models as affected by the number of context training examples. In this example experiment, a number of data sets were applied to XGBoost (in which they were used to train parameters of the model), TabPFN (without context training), and TabPFN with context training as discussed herein. In this example, TabPFN is used as a pre-trained model with a context size of 100 context points. A baseline 500 provides an example of the accuracy of XGBoost in which the training data is used to directly train parameters of the model. In the example of XGBoost, the size of the training data set does not significantly affect the performance of the model. However, when the model parameters are held constant, using the training data to train the context (termed “in-context distillation” (TCD)) provides an increasing benefit as the number of training data examples increases. As shown in FIG. 5, the performance line 520 for a TabPFN model without context training significantly degrades as the number of training examples increases. Because the context can only represent a limited number of training data examples (to define the context for applying TabPFN), the larger the data set is, the more nuance cannot be effectively represented in the limited size of the data context. However, context training significantly reduces the loss of TabPFN as data set size increases as shown by the performance line 510 for TabPFN-ICN.

As such, this approach enables significantly improved performance when context is used to guide evaluation of a data set with a pretrained model such as TabPFN. Rather than subsampling or randomly selecting context points, by training the context points, the context can learn what values of the points most improve model performance. As such, this approach enables significant enhancement of the scalability of TabPFN, allowing it to handle very large data sets while maintaining competitive performance against state-of-the-art algorithms.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for training a model context for a data set, comprising:
a processor configured to execute instructions;
a computer-readable medium having instructions executable by the processor for:
identifying a tabular computer model that receives a context of a plurality of context points and an input data point and outputs a classification of the input data point by applying a set of model parameters to the context and the input data point;
determining a training loss for a set of training points applied to the model with the context and the set of model parameters based on classification of the set of training points relative to respective training labels of the set of training points; and
training the plurality of context points to reduce the training loss with respect to training labels of the set of training points.

2. The system of claim 1, wherein the instructions are further executable for applying the computer model with the trained context to a new data point.

3. The system of claim 1, wherein the set of model parameters are fixed while training the plurality of context points.

4. The system of claim 1, wherein the set of model parameters is trained on a plurality of training sets other than the set of training points.

5. The system of claim 1, wherein the context points include class labels.

6. The system of claim 1, wherein the context points are tabular data.

7. The system of claim 1, wherein the plurality of context points are not in the set of training points.

8. The system of claim 1, wherein a number of the plurality of context points is smaller than a number of training points in the set of training points.

9. The system of claim 1, wherein a number of the plurality of context points is 100 or less.

10. The system of claim 1, wherein the tabular computer model is a TabPFN model architecture.

11. A method for training a model context for a data set, comprising:
identifying a tabular computer model that receives a context of a plurality of context points and an input data point and outputs a classification of the input data point by applying a set of model parameters to the context and the input data point;
determining a training loss for a set of training points applied to the model with the context and the set of model parameters based on classification of the set of training points relative to respective training labels of the set of training points; and
training the plurality of context points to reduce the training loss with respect to training labels of the set of training points.

12. The method of claim 11, wherein the method further comprises applying the computer model with the trained context to a new data point.

13. The method of claim 11, wherein the set of model parameters are fixed while training the plurality of context points.

14. The method of claim 11, wherein the set of model parameters is trained on a plurality of training sets other than the set of training points.

15. The method of claim 11, wherein the context points include class labels.

16. The method of claim 11, wherein the context points are tabular data.

17. The method of claim 11, wherein the plurality of context points are not in the set of training points.

18. The method of claim 11, wherein a number of the plurality of context points is smaller than a number of training points in the set of training points.

19. The method of claim 11, wherein a number of the plurality of context points is 100 or less.

20. The method of claim 11, wherein the tabular computer model is a TabPFN model architecture.
